(19) United States
(12) Patent Application Publication
(10) Pub. No.: US 2009/0031909 A1
(43) Pub. Date: Feb. 5, 2009

(54) Elongate Stamp Device

(75) Inventor: Ernst Faber, Wels (AT)

Correspondence Address: COLLARD & ROE, P.C., 1077 NORTHERN BOULEVARD, ROSLYN, NY, 11576, US

(73) Assignee: Colop Stempelerzeugung Skopek Gesellschaft M.B.H & Co. KG

(21) Appl. No.: 12/087,496

(22) PCT Filed: Jan. 11, 2007
(86) PCT No.: PCT/AT2007/000007

§ 371 Date: Jul. 8, 2008

(30) Foreign Application Priority Data
Jan. 25, 2006 (AT) GM 49/2006

(51) Int. Cl. B41K 1/22

(52) U.S. Cl. 101/329

(57) ABSTRACT

An elongate stamp device (1) having a pin-shaped base member (2) with two opposing ends (2′, 2″), a stamp wheel (3) being arranged on the one end (2′) of the base member (2) in a rotatably mounted manner on a rotational axis (10), wherein an end cap (4, 4′) fastenable to the base member (2) is provided for receiving the stamp wheel (3) in a transport position, wherein a further inking device (7, 15) is provided on the opposing end (2″) of the base member (2), a further end cap (8, 8′) fastenable to the base member (2) being provided for receiving the further inking device (7, 15) in a transport position, and the base member (2), in its cross-section, is substantially rectangular or elliptical and the rotational axis (10) of the stamp wheel (3) runs parallel to the longer one of the two cross-sectional axes (18′, 18″).

The invention relates to an elongate stamp device having a pin-shaped base member, a rotatably mounted stamp wheel being arranged on one of the two opposing ends of the base member and wherein an end cap fastenable to the base member is provided for receiving the stamp wheel in a transport position, wherein a further inking device is provided on the opposing end of the base member and a further end cap fastenable to the base member is provided for receiving the inking device in a transport position.

Such stamp devices, wherein a rotatable stamp wheel is provided on a pin-shaped base member or gripping member, are already known and have particularly been used for marking products in warehouses and the like. Here, it is often necessary to do other markings in the warehouse, wherein the known elongate stamp devices are, however, only suited for applying the stamping image provided on the stamp wheel. Hence, a further stamp device or a separate pen or the like is necessary for further markings.

From U.S. Pat. No. 6,615,719 B, a stamp device having a separate gripping member is known, one stamp device each being fastenable to the opposing ends of the gripping member. Here, a stamp device may also have a pre-inked printing plate, which is wound about a rotational axis to form a stamp wheel. The rotational axis of the stamp wheel is arranged perpendicularly to the longer direction of extension of a housing, which renders extremely unhandy the inking by means of the stamp wheel. For covering the stamp wheel, a cap, which is freely detachable from the housing, may be provided. On the opposing end of the gripping member, a different stamp device having a planar printing plate to the separate gripping member may be fastened.

From DE 195 26 444 A, a writing device is known, wherein a stamp is provided on the rear part thereof, said rear part being received by a closing cap and, in this position, pressing against an ink pad. After the cap has been opened, the stamp plate is pivoted together with the ink pad. In this document, no stamp wheel is shown.

In DE 3243970 A, also a stamp device is disclosed which is fastened to a shaft-shaped fastening member, wherein, here, however, only a stamp plate is shown which is arranged on the opposing end to a writing device on the fastening member.

From U.S. Pat. No. 5,118,212 A, also a writing device including a stamp device is known. Here, the stamp plate is turned by 180 degree to put it into its stamping position.

In DE 28 27 542 A, also a writing device including a stamp device is disclosed, said stamp device being received in the rear part and having a pivotable stamp plate carrier and a pivotable ink pad carrier.

From GB 2 169 561 A, a further writing device is known which comprises an end cap, an ink pad being provided on the inner end face thereof for inking an ink pad of a further end cap.

Accordingly, it is an object of the present invention to create a handy, elongate stamp device of the initially defined kind, by means of which not only the stamping image provided on the stamp wheel may be applied onto a surface to be imprinted, but at the sime time also a further marking my be applied, wherein particularly also the inking may be possible via the stamp wheel in a manner comfortable for the user.

According to the invention, this is achieved in that the base member, in its cross-section, is substantially rectangular or elliptical, and in that the rotational axis of the stamp wheel extends parallel to the longer one of the two cross-sectional axes. By orienting the axis of the stamp wheel parallel to the longer direction of extension of the substantially rectangular or elliptical base member, an ergonomically beneficial position of the hand is rendered possible when rolling the stamp wheel. Here, the base member, substantially with its shorter side, may be positioned between the thumb and forefinger to enable an inking in a pleasant manner via the stamp wheel, which is comparable to, e.g. the highlighting of parts of a text using a marker pen.

A design of the stamp wheel simple in terms of construction for applying a stamp image is the case if the stamp wheel comprises an inked printing plate wound about a rotational axis.

If at least one end cap is freely detachable from one end of the base member, it is reliably ensured that the stamp wheel or the further inking device may unhinderedly be used when the end cap is in its detached position.

If the end cap receiving the stamp wheel is pivotally mounted on the base member, it may be pivoted on the base member in a simple fashion for changing between the transport position and the inking position such that an unintended loss of the end cover is reliably prevented also during applying the stamp image provided on the stamp wheel onto a surface to be imprinted.

In order to be able to do another marking with the elongate stamp device, it is beneficial if a pin-shaped inking element is provided as a further inking device. Here, for highlighting parts of a text, it is particularly advantageous if a light pen, which dispenses a fluorescent color, i.e. a so-called highlighter or marker pen, is provided as a further inking device.

As an alternative to a pin-shaped inking element, particularly a light pen or marker pen, it is also possible that a stamp comprising a stamp plate is provided as a further inking device, wherein a printing plate is arranged on the stamp plate, and wherein the stamp plate is pivotally mounted on one retention arm of the base member. Thus, at least two different stamp images may be applied onto a surface to be imprinted by means of one and the same elongate stamp device via the stamp wheel and the stamp plate.

In order to re-ink the printing plate in the transport position, it is advantageous if the stamp comprises an ink pad carrier pivotally mounted on a base member and receiving an ink pad, wherein the printing plate rests on the ink pad when the end cap is in its attached transport position.

In the following, the invention will be explained in even more detail by way of the preferred exemplary embodiments illustrated in the drawings, yet without being restricted thereto. In detail, in the drawings:

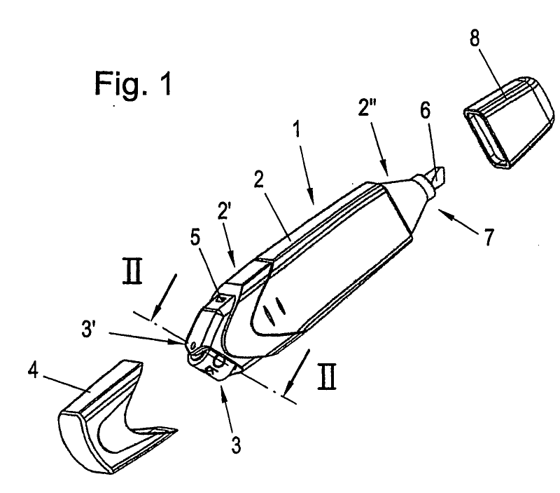

FIG. 1 shows a perspective view of an elongate stamp device with a stamp wheel arranged on one end of a pin-shaped base member and with a light pen provided on the opposing end;

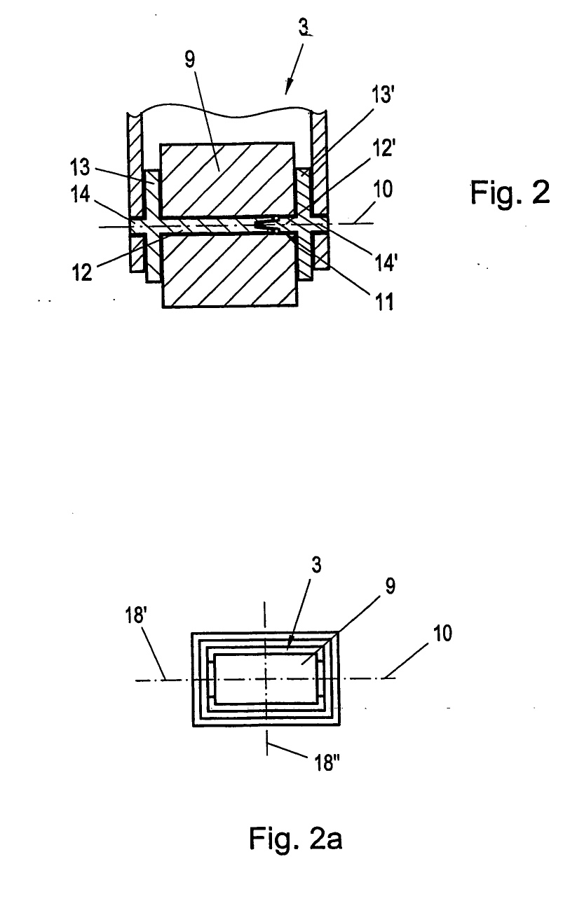

FIG. 2 shows a section according to line II-II in FIG. 1;

FIG. 2a shows a top view on that end of the stamp device including the stamp wheel;

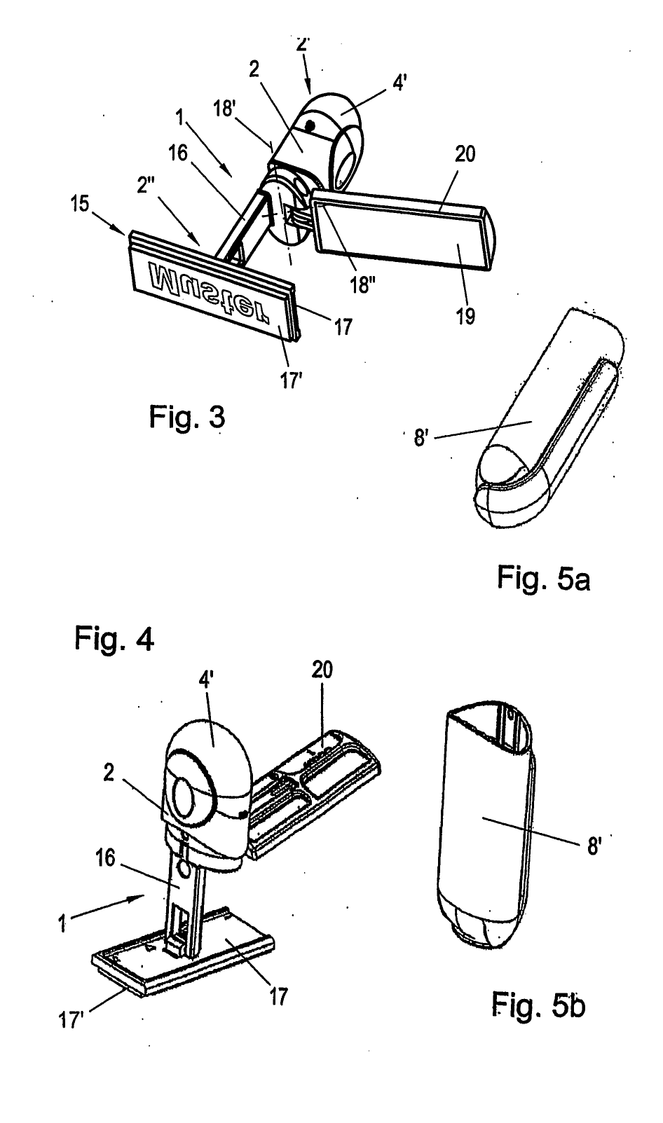

FIGS. 3 and 4 show perspective views of an elongate stamp device, wherein on that end of the base member opposing the stamp wheel a pivotally mounted stamp plate is provided;

FIGS. 5a and 5b show perspective views of an end cap to be attached to the base member;

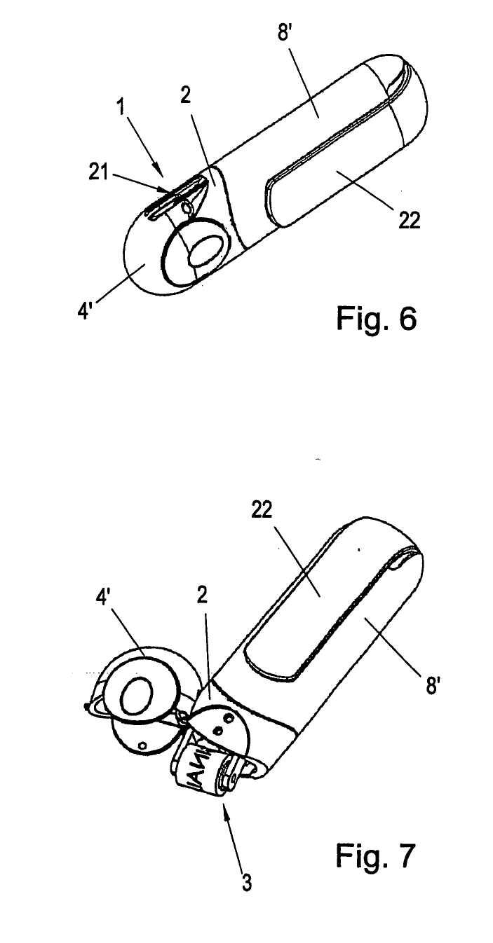

FIG. 6 shows a perspective view of an elongate stamp device in the transport position with a pivotable end cap; and

FIG. 7 shows a perspective view of the elongate stamp device according to FIG. 6 with the pivotable end cap in a pivoted inking position.

In FIG. 1, an elongate stamp device 1 having a substantially pin-shaped base member 2 is shown, said base member having two opposing ends 2′, 2″. Here, a stamp wheel 3 is rotatably mounted on the end 2′ of the base member 2, which, in its cross-section, is substantially rectangular.

In order to prevent possible contamination during the transport of the stamp device 1 and when no inking is to be done, an end cap 4 is provided which can be attached to the end 2′ and which covers the stamp wheel 3 in its attached position. For a reliable snap-on of the end cap 4 on the end 2′ of the base member 2, the latter has one snap-in lug 5 on either narrow side, which snap-in lug snaps into a corresponding snap-in groove in the end cap 4.

In the exemplary embodiment shown in FIG. 1, a pin-shaped inking element 6 of a light pen or marker pen 7 can be seen on the opposing end 2″ of the pin-shaped base member 2, said inking element 6 being integrated into the base member 2 of the elongate stamp device 1. An end cap 8 is also attachable to the end 2″ of the base member 2 in order to avoid the light pen 7 from getting contaminated when it is not being used.

In FIG. 2, the stamp wheel 3 is shown in detail, wherein it can be seen in the sectional representation that a printing plate 9 having a stamp image is wound about a rotational axis 10. Here, the rotational axis 10 is formed by two sections 12, 12′ of the axis assembled by a friction-fit pin-hole-connection 11, said sections each having a lateral cover disk 13, 13′. Bearing pins 14, 14′ follow the cover disks 13, 13′, said bearing pins being received in a bearing bush 3′ of the base member 2 for the rotatable mounting of the stamp wheel 3 (cf. FIG. 1).

As can be seen particularly from FIG. 2a, the rotational axis 10 runs parallel to, and in the case shown it is even coincident with, a longer cross-sectional axis or axis of symmetry 18′ of the base member 2, which, in its cross-section, is rectangular. As well as the cross-sectionally substantially elliptical base member 2 shown in FIGS. 3 to 7, the rectangular base member 2 shown in FIG. 1 has two axes of symmetry or cross-sectional axes 18′, 18″, as can be seen in FIG. 2a, wherein the longitudinal extension of the base member is larger in the direction of the cross-sectional axis 18′ than in the region of the cross-sectional axis 18″. In order to allow an ergonomic use of the stamp wheel 3 for the user, the rotational axis 10 of the stamp wheel 3 in each case is arranged in parallel to, and/or coincident with, the cross-sectional axis 18′.

In FIGS. 3 and 4, an alternative exemplary embodiment is shown, wherein a base member 2, which, in its cross-section, is substantially elliptical, is provided, and wherein, instead of the light pen 7, a stamp 15 having a stamp plate 17 pivotally mounted on one retention arm 16 of the base member 2 is provided on the end 2′ opposing the end 2″ (on which the stamp wheel 3 is arranged). For applying a stamp image, a printing plate 17′ is located on the stamp plate 17, which, in a transport or inking position, in which an end cap 8′ shown in FIGS. 5a and 5b is attached to the base member 2, contacts an ink pad 19, wherein the latter is received by an ink pad carrier 20, which is also pivotally mounted on a base member 2.

In FIG. 6, the stamp device 1 according to FIGS. 3 and 4 is shown in a transport position, in which the end cap 8′ is put over the stamp plate 17 and the ink pad carrier 20 and is snapped-on on the base member 2. Likewise, in FIG. 6, an end cap 4′ is shown in a transport position pivoted and put over the stamp wheel 3.

As can be seen from FIG. 7, for putting the end cap 4′ in an inking position, the end cap 4′ is pivotally mounted about a pivot axis 21, which is provided in parallel to the narrower cross-sectional axis of the base member 2, which, in its cross-section, is substantially elliptical. Thus, a loss of the end cap 4′ is also reliably prevented in the inking position of the stamp wheel 3.

Moreover, the whole stamp device 1 may be attached to a pocket of a shirt or a sports jacket by the aid of an attachment clip 22 arranged on the end cap 8′. The only essential thing is that, in addition to the stamp image to be applied with the stamp wheel 3, a further inking device 7, 15 is integrated into a single base member 2, which, in its cross-section, is substantially rectangular or elliptical, wherein the rotational axis 10 of the stamp wheel 3 runs parallel to the direction of longitudinal extension of the base member in the cross-section.

1: An elongate stamp device (1) having a pin-shaped base member (2) with two opposing ends (2′, 2″), a stamp wheel (3) being arranged on the one end (2′) of the base member (2) in a rotatably mounted manner on a rotational axis (10), wherein an end cap (4, 4′) fastenable to the base member (2) is provided for receiving the stamp wheel (3) in a transport position, wherein a further inking device (7, 15) is provided on the opposing end (2″) of the base member (2), a further end cap (8, 8′) fastenable to the base member (2) being provided for receiving the further inking device (7, 15) in a transport position, wherein the base member (2), in its cross-section, is substantially rectangular or elliptical, and wherein the rotational axis (10) of the stamp wheel (3) runs parallel to the longer one of the two cross-sectional axes (18′, 18″).

2: The stamp device according to claim 1, wherein the stamp wheel (3) comprises an inked printing plate (9) wound about a rotational axis (10).

3: The stamp device according to claim 1, wherein at least one end cap (4, 8, 8′) is freely detachable from one end (2′, 2″) of the base member (2).

4: The stamp device according to claim 1, wherein the end cap (4′), which receives the stamp wheel (3), is pivotally mounted on the base member (2).

5: The stamp device according to claim 1, wherein a pin-shaped inking element (6) is provided as a further inking device (7).

6: The stamp device according to claim 5, wherein a light pen, which dispenses a fluorescent color, is provided as a further inking device (7).

7: The stamp device according to claim 1, wherein a stamp (15), which comprises a stamp plate (17), is provided as a further inking device (15), wherein a printing plate (17′) is arranged on the stamp plate (17), and wherein the stamp plate (17) is pivotally mounted on a retention arm (16) of the base member (2).

8: The stamp device according to claim 7, wherein the stamp (15) has an ink-pad carrier (20), which is pivotally mounted on the base member (2) and receives an ink pad (19), wherein the printing plate (17′) rests on the ink pad (19) when the end cap (8′) is in the attached transport position.
